(19) United States
(12) Patent Application Publication
(10) Pub. No.: US 2019/0227291 A1
(43) Pub. Date: Jul. 25, 2019

(54) FLUORESCENCE MICROSCOPE

(71) Applicant: The Board of Trustees of the Leland Stanford Junior University, Stanford, CA (US)

(72) Inventors: Christian Andrew Stokes, Denver, CO (US); Bradley Willard Stokes, Minneapolis, MN (US); Christopher H. Contag, San Jose, CA (US)

(21) Appl. No.: 16/324,790

(22) PCT Filed: Aug. 11, 2017
(86) PCT No.: PCT/US2017/046491

§ 371 Date: Feb. 11, 2019

Related U.S. Application Data
(60) Provisional application No. 62/373,603, filed on Aug. 11, 2016.

(51) Int. Cl. G02B 21/00; G02B 21/36

(52) U.S. Cl. CPC G02B 21/0076; G02B 21/0048; G02B 21/0032; G02B 21/361

(57) ABSTRACT

A fluorescence microscope includes a color filter array for use in conjunction with an imaging array to produce a full color image without the use of an excitation filter, a dichroic, and an emission filter. In some embodiments, optics include a reverse upright (camera) lens to provide a field-of-view significantly larger than that of prior art fluorescence microscopes.

### STATEMENT OF RELATED CASES

This case claims priority to U.S. Patent Application Ser. No. 62/373,603 filed Aug. 11, 2016, which is incorporated herein by reference.

### STATEMENT REGARDING FEDERALLY-SPONSORED RESEARCH

This invention was made with Government support under National Institutes of Health Grant #: 1165058-100-PADGN. The Government has certain rights in the invention.

### BACKGROUND OF THE INVENTION

Optical fluorescence is a process that occurs when a molecule absorbs light at wavelengths within its absorption band, and then emits light (at longer wavelengths) within its emission band. This process can be used to study specimens that can be made to fluoresce. A specimen can fluoresce in its natural form or as a consequence of being treated by strongly fluorescing molecules known as fluorophores. The fluorophores can be attached to specific targets, which are often biological molecules. This provides a means for identification, quantification, and real-time observation of biological and/or chemical activity of such molecules. By using several different fluorophores, which fluoresce at different wavelengths (colors), several different target molecules can be examined simultaneously. For this reason, fluorescence detection techniques are of increasing importance in biological research microscopy.

Fluorescence can be examined using a fluorescence microscope. This is an optical microscope that uses fluorescence and/or phosphorescence instead of, or in addition to, reflection and absorption to study properties of organic or inorganic substances. Although the fluorescence microscope cannot provide spatial resolution below the diffraction limit of specific specimen features, the detection of fluorescing molecules below such limits is readily achieved.

The fluorescence microscope uses a broadband light source, which in addition to providing other (unwanted) wavelengths of light, will provide wavelength(s) that excite the one of more fluorophores being used. To select the excitation wavelength(s) and separate emitted fluorescence from excitation light, the fluorescent microscope typically uses a minimum of three filters: an excitation filter (“exciter”), a dichroic beamsplitter/mirror (“dicroic”), and an emission or barrier filter (“emitter”).

The exciter is a bandpass filter that passes only the wavelengths absorbed by the fluorophore, thereby substantially preventing the excitation of other sources of fluorescence. Additionally, the exciter blocks excitation light in the fluorescence emission band. The dichroic is an edge filter used at an oblique angle of incidence, usually 45 degrees, to efficiently reflect light in the excitation band and to transmit light in the emission band. And the emitter is a bandpass filter for passing only the wavelengths emitted by the fluorophore, blocking all undesired light outside this band, particularly the excitation light. By blocking unwanted excitation energy (including UV and IR) or sample and system auto-fluorescence, these optical filters ensure the darkest background.

FIG. 1 depicts conventional fluorescence microscope 100. The microscope includes light source 102, excitation filter 104, dichroic beamsplitter 106, emission filter 108, stage 110, and detector 112, arranged as depicted. Certain other components that are normally present in microscope 100, such as an ocular, objective, etc., are not shown. A fluorophore, having an excitation wavelength λⱼ and an emission wavelength λₚ, is assumed to have been attached to a target molecule in sample 114.

Light source 102, which is typically a broad band light source, emits light comprising a plurality of wavelengths, including wavelengths λ₁ to λₙ, which includes the excitation wavelength λⱼ. Excitation filter 104 selectively blocks light having wavelengths other than excitation wavelength λⱼ, enabling only light having wavelength λⱼ to pass. Dichroic beamsplitter 106 receives and reflects the excitation light (as passed by excitation filter 104) and directs it to sample 114 on stage 110.

Light propagating away from sample 114 includes fluorescent emissions (i.e., wavelengths λₚ and λₛ-λ_{z}) as well as excitation light (wavelength λⱼ) that is simply scattered therefrom. Dichroic beamsplitter 106 separates the fluorescent emissions from the scattered excitation light, diverting the scattered excitation light away from the detection path.

Emission filter 108 selectively transmits, for detection at detector 112, fluorescent emissions having wavelength λₚ from sample 114 and blocks fluorescent emissions having other wavelengths (λₛ-λ_{z}).

Detector 112 can be a charge-coupled device (CCD) or CMOS image sensor. Traditionally, complementary metal-oxide semiconductor (CMOS) cameras have not been used in scientific applications due to their poor sensitivity and high noise relative to more traditional charge-coupled device (CCD) image sensors. CCDs have two architectural differences that had made them ideal for scientific use. First, the analog-to-digital conversion and signal amplification occur off of the image sensor, thereby reducing noise and making the CCD essentially an analog device that utilizes shift registers to read out the image. Second, a CCD does not require transistors to address each individual pixel, enabling 100% active pixel area. But with improvements in CMOS processing technologies, and the development of the “scientific” CMOS sensors (“sCMOS”), such sensors have been appearing in fluorescence microscopes.

Optical filters 104 and 108 and dichroic beamsplitter 106 are chosen to match the spectral excitation and emission characteristics of the fluorophore used to label sample 114. In this manner, the distribution of a single fluorophore (color) is imaged at a time. To create a multi-color image involving several types of fluorophores, several single-color images must be combined, such as with the use of a color wheel.

The optical filters perform a critical function in separating the fluorescence emission photons that form a final image from the excitation light, which is far more intense. In fact, the excitation light intensity in the detection path must typically be reduced by a factor of 10⁶-10⁷. At the same time, the amount of available fluorescence photons captured must be maximized to the extent possible. High capture efficiency enables reductions in overall excitation-light levels, with accompanying reductions in dye photobleaching and cellular phototoxicity.

The selection of the filters often involves a complex analysis of the spectral relationships of dyes and optical filters. In situations in which a single dye is used, the excitation and emission filters should be centered on the dye's absorption and emission peaks. To maximize the signal, excitation and emission filters with wide bandwidths are selected. But this might result in an unacceptable level of overlap of the emission signal with the excitation signal, resulting in poor resolution. To minimize such spectral overlap, excitation and emission filters having narrow bandwidths and spectrally well separated to increase signal isolation can be selected. This approach reduces optical noise, but might also unacceptably reduce the signal strength. When overlapping signals from multiple fluorophores in the same sample are being differentiated, both the spectra of the dyes and theft expected intensities must be considered when choosing an optical filter.

A further consideration with respect to filters is that some dyes have significantly different spectral properties in a particular application than those reported for the dye in solution. For example, the spectral characteristics of many nucleic add stains depend on whether the dyes are in aqueous solution or bound to DNA or RNA. Other dyes have emission maxima that depend on whether they are dissolved in solvent or associated with membranes.

All fluorescent microscopes use the basic technique and arrangement described above. See, for example, the fluorescence microscopes offered by Leica, Nikon, Zeiss, Thermofisher, and others: http://www.leica-microsystems.com/applications/life-science/fluorescence/; https://www.microscopyu.com/techniques/fluorescence/introduction-to-fluorescence-microscopy; http://zeiss-campus.magnet.fsu.edu/articles/basics/fluorescence.html; https://www.thermofisher.com/us/en/home/life-science/cell-analysis/cell-analysis-learning-center/molecular-probes-school-of-fluorescence/fundamentals-of-fluorescence-microscopy/ epifluorescence-microscope-basics.html; https://www.edmundoptics.com/resources/application-notes/optics/fluorophores-and-optical-filters-for-fluorescence-microscopy/; and https://www.news-medical.net/life-sciences/Advances-in-Fluorescence-Microscopy.aspx.

In addition to a need to resolve color for fluorescence detection, some microscopy applications in the biosciences require a large field-of-view (FOV) at high resolution. This presents a fundamental problem in optical design since trade-offs in FOV and resolution are always inversely related in traditional imaging systems.

A common solution to this problem has been the development of high-resolution microscopes that are capable of producing large field-of-view images through the use of image tiling and scanning stages. However, that significantly slows the process of image acquisition.

The art would therefore benefit from improvements in fluorescence microscopes.

### SUMMARY OF THE INVENTION

The present invention provides a fluorescence microscope and method for fluorescence detection that avoids some of the drawbacks of the prior art.

In accordance with the present teachings, and unlike the prior art, a color filter array (“CFA”) is used in conjunction with a CMOS imaging array to provide a fluorescence microscope that is capable of imaging multiple fluorophores and/or bioluminescent reporters.

The present inventors recognized that the set of macroscopic filters (i.e., excitation, dichroic, emission) used in conventional fluorescence microscopes could be replaced by a CFA. More particularly, in embodiments of the invention, a color camera—a CFA and CMOS imaging array—replaces the macroscopic filters of prior-art fluorescence microscopes. It is notable that to the extent sCMOS imaging arrays have been used in fluorescence microscopes, they have not included a CFA.

In the illustrative embodiment, the CFA is the well-known Bayer filter, which is a multispectral filter array that has been used for most standard color image sensors since 1976. The filter overlies an imaging array, such as a CMOS imaging array. The Bayer filter consists of one red, two green and one blue filter in a repeating pattern, one filter per imaging pixel. Because each pixel is filtered to receive light of only one of three colors (for a Bayer CFA), the missing values of the other two colors (i.e., red/green, red/blue, or blue/green) must be estimated to obtain a full color image. The estimation is performed by a demosaicing algorithm. The algorithm typically makes use of surrounding pixels having corresponding colors to estimate the values for a particular pixel, such as via interpolation techniques or other mathematical processing. Based on voltages obtained from each R, G, and B pixel and the estimates provided by the demosaicing algorithm, a color image is generated using a ratio of the intensity of R:G:B. The illumination light is subtracted from the image utilizing the excitation wavelengths' known R:G:B ratio to ensure that as much illumination noise as possible is removed.

The Bayer filter enables, at a minimum, single-image multiplexing of up to three fluorophores if the emission of each fluorophore falls within the spectral response of either an R, G, or B pixel, under the condition that no two fluorophores have significant overlap of their respective emission spectrums. Such overlap would cause crosstalk between the RGB channels. Using absorption valleys between the blue/green pixels and green/red pixels, five fluorophores can be multiplexed. It is expected that up to twelve fluorophores could be multiplexed as long as the emission wavelengths of the fluorophores differs by at least about 25 nm.

In some other embodiments, other CFAs can be used, such as, without limitation, an RGBE filter, CYYM filter, CYGM filter, RGBW Bayer, RGBW #1, RGBW #2, RGBW #3, X-Trans, or others.

Thus, in accordance with the invention, each pixel of the imaging array includes its own “built-in” color filter and spectral unmixing capability. This results in a far simpler architecture for a fluorescence microscope, in addition to being faster and lower cost than conventional fluorescence microscopes, such as microscope 100.

A fluorescence microscope in accordance with the present teachings includes a detector, a light source, optics, a stage, and a body. The body, which in some embodiments is a high-density polyethylene, protects the internal components (e.g., detector, light source, and optics, etc.) and tolerates cleaning with acetone, bleach, or acid. As such, the microscope is well-suited for imaging applications in BL2 to BL4 laboratories where disinfection of work surfaces is critical.

In operation, light is emitted from the light source and illuminates the sample. In addition to reflecting some of the illumination light, the sample generates certain wavelengths of light due to the presence of fluorescent markers or due to its natural composition (i.e., naturally occurring fluorescence-generating organic/inorganic structures or light-producing enzymes). All of this light composes an optical signal that is collected by the optics and delivered to a detector. Depending upon the nature and arrangement of the optics, as employed in various embodiments, the optics provides, among any other functions, magnification, and/or an adjustable focal length, and/or an approach for obtaining a very large (compared to prior-art fluorescence microscopes) field-of-view. The color filter array that forms part of the detector enables the microscope to generate a full color image.

In some embodiments, the detector is embodied as a consumer camera that includes a color CMOS imaging array of light sensing elements. In some other embodiments, the detector is embodied as an array of light-sensitive elements, such as photodetectors, photodiodes, charge-coupled devices, and the like. In some such embodiments, the array of light-sensitive elements is a CMOS or sCMOS imaging array. In some further embodiments, the detector is embodied as plural arrays of light-sensitive elements, such as plural CMOS or sCMOS imaging arrays.

In some embodiments, the light source comprises plural LEDs, each emitting at the same nominal wavelength, such as 265 nanometers (nm). In some other embodiments, the light comprises groups of LEDs, each group including LEDs having different nominal emission wavelengths, such as 265 nm, other UV wavelengths longer than 265 nm, white light, etc.

In some embodiments, the optics comprises a microscope objective to provide magnification of a sample being imaged. In some other embodiments, the optics comprises camera lenses, rather than microscope lenses. The aperture of a microscope objective is measured in millimeters; by contrast, the aperture of a camera lens is measured in centimeters. The use of camera lenses, rather than microscope objectives, therefore significantly increases the light-collection capability of embodiments of the invention.

In some embodiments, the optics comprises two camera-lens assemblies, arranged and specified to effectively optically place the sample on the detector, thereby maximizing the field-of-view of the camera. That is, the optics results in an image that maps to the detector's entire imaging area.

In some embodiments, one of the two lens assemblies is a reversed upright lens. In some embodiments, one of the two lens assemblies is a telephoto lens. In some embodiments, one of the lens assemblies is a reversed upright lens and the other of the lens assemblies is a telephoto lens. In some embodiments, the lens assembly closest to the stage is disposed vertically and the lens assembly closest to the detector is disposed horizontally, wherein a first (front) surface mirror is positioned to redirect the optical signal (i.e., fluorescence, bioluminescence, etc.) exiting the vertically oriented lens assembly so that it can be received by the horizontally oriented lens. In all embodiments, the fluorescence microscope excludes an excitation filter, a dichroic, and an emission filter.

In some embodiments in which the detector is a consumer camera, the lens assembly nearest to the consumer camera is physically coupled thereto. In some embodiments, the reversed upright lens has a fixed focal length of 85 millimeter (“mm”) and a f1.4 aperture and the telephoto lens has a focal length adjustable within the range of 75 mm to 300 mm.

In some embodiments, a super-sampling technique is employed wherein in addition to capturing (for the Bayer CFA) four images (1 red pixel, 2 green pixels, and 1 blue pixel), an additional four images are obtained at “bridging” locations (between the four pixels being examined and their neighbors). This reduces effective pixel size and increases resolution.

In some embodiments in accordance with the present teachings, the fluorescence microscope measures (the size of the housing) about 178 mm×229 mm×229 mm. In some such embodiments, the detector is a consumer camera, model OMD E-M5 Mark II, available from Olympus Corporation. The camera has a resolution of 4608×3456 pixels and a pixel size of 3.6 microns. The camera includes a super-sampling protocol as previously discussed, wherein an image-stabilization voice coil motor physically moves the imaging array to obtain additional samples of the pixels, thereby reducing the effective pixel size from 3.6 microns to 1.8 microns.

The unique assembly of components in some embodiments of a fluorescence microscope in accordance with the present teachings provides a device that rivals the resolution of prior-art fluorescent microscopes with a 10× objective, but far exceeds the field-of-view of all such microscopes reported to date. In fact, embodiments of the invention incorporating the reversed upright lens produces an image that maps to its entire field-of-view at 4 μm resolution and provides a frame of reference with real-time display and ease of use by connecting to any viewing device with an HDMI or USB port.

Embodiments of the present invention have broad utility. For example, in the field of pathology, the ability to generate a single image showing macroscopic and microscopic features as well as fluorescent molecular markers will refine and accelerate the assessment of tissue pathology. The current paradigm in pathology often limits the examination to no more than a few square millimeters of a given tissue section largely because of the number of tissue sections pathologists are required to examine within a fixed period of time. Currently, only a selected portion of an excised biopsy is fixed and undergoes histological embedding, sectioning, and staining prior to examination by the pathologist. Due to these methods, both the surgeon and patient do not receive the pathology results prior to leaving the hospital, and, in many cases, the patient is required to return for additional surgery to remove cancerous tissue because margins of the excised tissue were found to be malignant upon histological examination. Although re-excision is often deemed necessary to reduce the chance for recurrence, secondary surgery following primary excision is complicated by wound-healing related distortions in tissue landmarks and the development of fibrotic tissue.

Embodiments of the invention having an expanded FOV and that can acquire high-resolution images in near real time will greatly aid pathologists, surgeons and patients by enabling evaluation of freshly excised, large tissue samples without significantly impacting productivity, thereby permitting informed, or guided, tissue sectioning. And when combined with targeted-molecular probes, embodiments of the invention aid in the rapid and accurate delineation of pathological margins, possibility intraoperatively. This will lead to greater precision in surgical resection and better patient outcomes, while, concurrently, reducing hospital costs by reducing the need for re-excision and post-operative radiotherapy.

Embodiments of the invention also have utility in live cell and organoid imaging by enabling detection of fluorescent and bioluminescent reporters in addition to white-light reference images. It also has applications in biology for the imaging of relatively small and transparent model organisms such as flies, worms and fish, as well as plants. Embodiments of the invention can also be used in the food safety arena, enabling efficient and accurate evaluation of meat products for contamination.

Embodiments of the invention will have utility in cell and organ culture laboratories where live cell and tissue imaging with multiplexed reporters are used since there is very little sample preparation required. The stage of a fluorescent microscope in accordance with the present teachings does not require special consideration when preparing samples; in fact, freshly stained tissues can be placed directly on the stage glass, which can also be readily cleaned or disinfected.

In summary, embodiments of the invention provide a low-cost, sensitive, wide-field microscope with fluorescence and white-light capability that can generate images at relevant resolutions and relatively short acquisition times to guide pathologic assessment or for other study.

### BRIEF DESCRIPTION OF THE DRAWINGS

FIG. 1 depicts a prior-art fluorescence microscope.

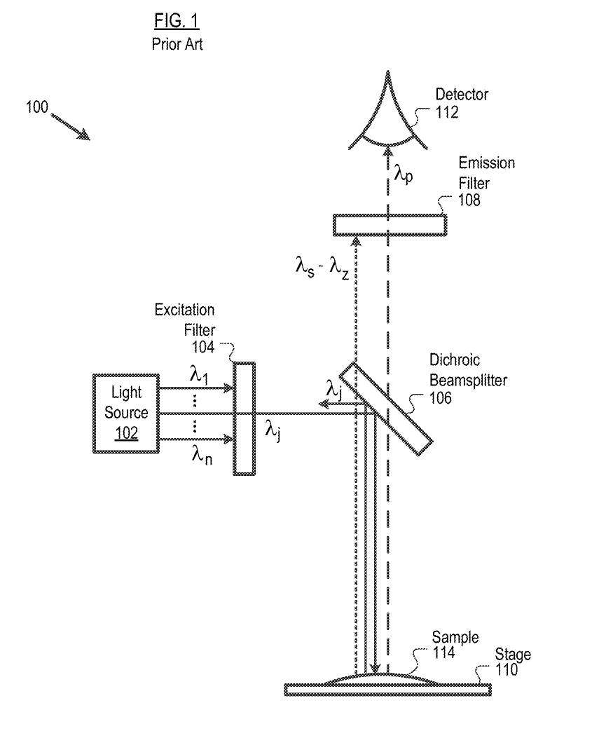

FIG. 2 depicts a fluorescence microscope in accordance with the illustrative embodiment of the present invention.

FIG. 3 depicts a color filter array and an imaging array for use in conjunction with the fluorescence microscope of FIG. 2.

FIGS. 4A through 4I illustrate sampling and super-sampling of a Bayer filter, for use in conjunction with some embodiments of the fluorescence microscope of FIG. 2.

FIGS. 5A through 5C depict embodiments of optics for use in conjunction with some embodiments of the fluorescence microscope of FIG. 2.

FIGS. 6A through 6C depicts arrangements of plural imaging modules for use in conjunction with some embodiments of the fluorescence microscope of FIG. 2.

### DETAILED DESCRIPTION

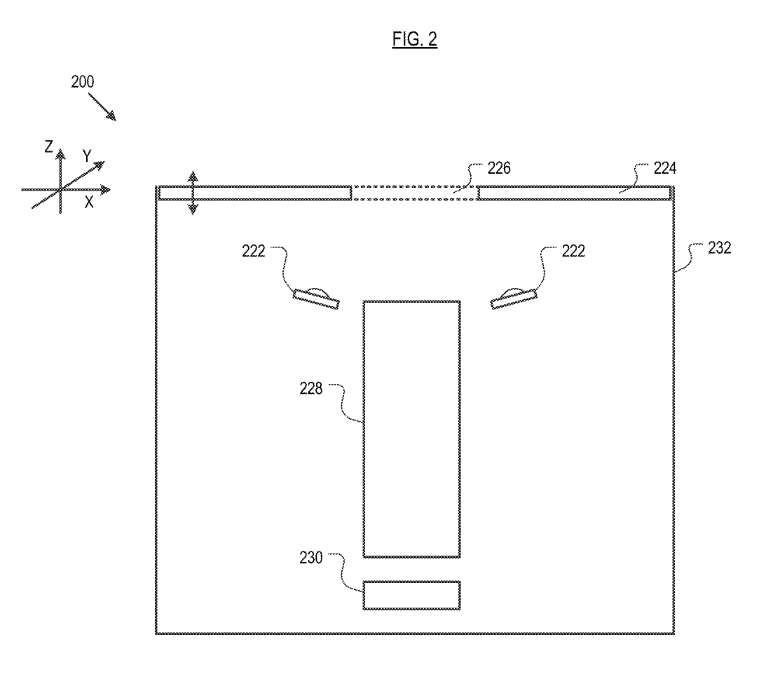

FIG. 2 depicts fluorescence microscope 200 in accordance with the present teachings. Fluorescence microscope 200 includes light source 222, stage 224, optics 228, detector 230, and housing 232.

Housing 232 protects various elements (light source 222, optics 228, detector 230) of fluorescence microscope 200. In some embodiments, housing 232 comprises a material that is resistant to degradation on exposure to cleaning fluids. In the illustrative embodiment, the housing comprises a high-density polyethylene.

In some embodiments, light source 222 comprises two or more groups of high powered LEDs, each group including plural LEDs having different illumination wavelengths. A rotary switch, for example, is used to select a LED from each group having a particular desired illumination wavelength. In some other embodiments, light source 222 comprises two or more LEDs having the same illumination wavelength, for example, 265 nanometers (nm). The brightness of the LEDs can be controlled, for example, via a potentiometer that is coupled with a pulse width modulator.

Stage 224 supports a sample (not depicted). At least a portion 226 of stage 224 is optically transparent at wavelengths of interest (e.g., the excitation wavelength, emission wavelength, etc.), comprising, for example and without limitation, quartz glass. The stage is movable in the Z-direction (i.e., up/down in FIG. 2, as indicated by the arrow) to adjust focus. For movement, stage 224 is coupled to a scissor jack or other device capable of effecting small, controllable movements in the Z-direction.

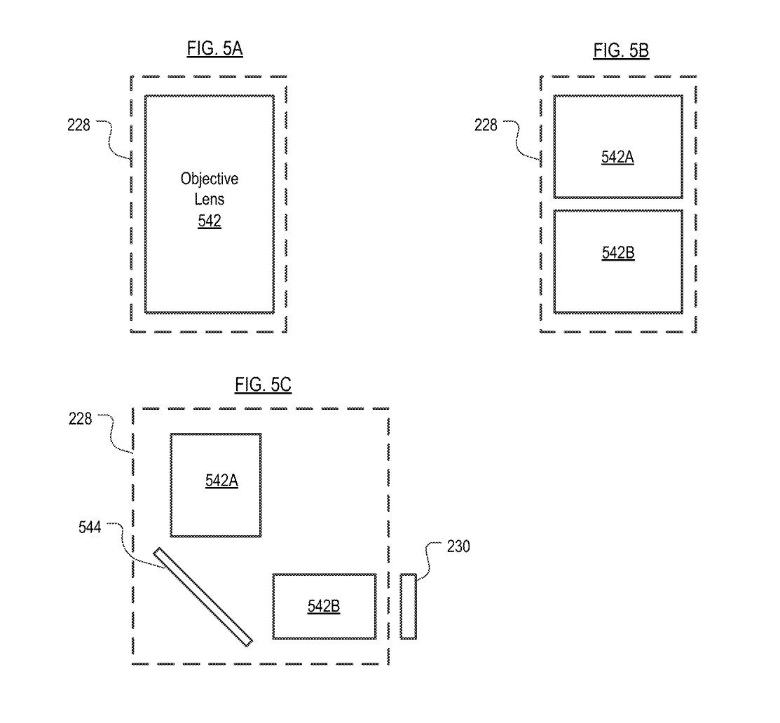

Optics 228 controls magnification and field-of-view of the microscope. Optics 228 is discussed in further detail later in this specification in conjunction with FIGS. 5A through 5C.

Detector 230 detects the optical signal delivered by optics 228. As described more fully below, in various embodiments, detector 230 is:
a consumer camera containing a CMOS imaging array;
a CMOS imaging array (i.e., without the body, etc., of a consumer camera);
a sCMOS imaging array; or
plural CMOS or sCMOS imaging arrays.
   The photosensors in a CMOS imaging array detect light intensity with virtually no wavelength specificity and therefore cannot resolve color information. However, in all embodiments of the present invention, the image sensor is capable of resolving color via the use of a color filter array (CFA). The CFA is a mosaic of very small color filters that are disposed over each pixel (i.e., light-sensing element) of the imaging array. The color filters filter the light by wavelength range.

The most common CFA is the Bayer filter, which provides information about the intensity of light in red, green, and blue wavelength regions in the Bayer filter, a single color filter (red, green, or blue) is associated with each pixel. Thus, only one of the three colors is detected at any given pixel of the imaging array. A demosaicing algorithm is used to interpolate the missing color samples. Thus, the raw image data captured by the image sensor is converted to a full-color image, with the intensities of all three primary colors represented at each pixel.

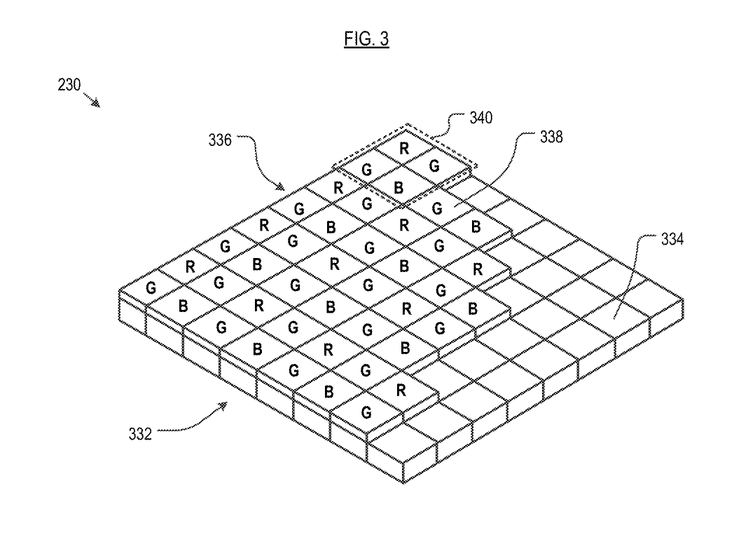

FIG. 3 depicts an embodiment of detector 230, wherein CFA 336, implemented as the well-known Bayer filter, is used in conjunction with CMOS imaging array 332.

As depicted, a Bayer filter comprises plural 2×2 grids 340 of color filters, which overlie the camera's light-sensing elements (pixels) 334. Each grid 340 includes two green (“G”) filters, one red (“R”) filter, and one blue (“B”) filter. In a typical arrangement, there is a red filter and a green filter in the first row of the 2×2 grid, and a green filter and a blue filter in the second row (“RGGB”). This 2×2 grid is repeated over all of the cameras pixels. (In FIG. 3, some of the filters are omitted for pedagogical purposes.) As depicted, one filter element 338, either a red (R), green (G), or blue (B) filter, is associated with each pixel 334 of array 332. Consequently, only one spectral component—red, green, or blue—is sensed at each pixel; the other spectral components must be estimated from neighboring pixels using various demosaicing algorithms, which use interpolation and/or other mathematical techniques.

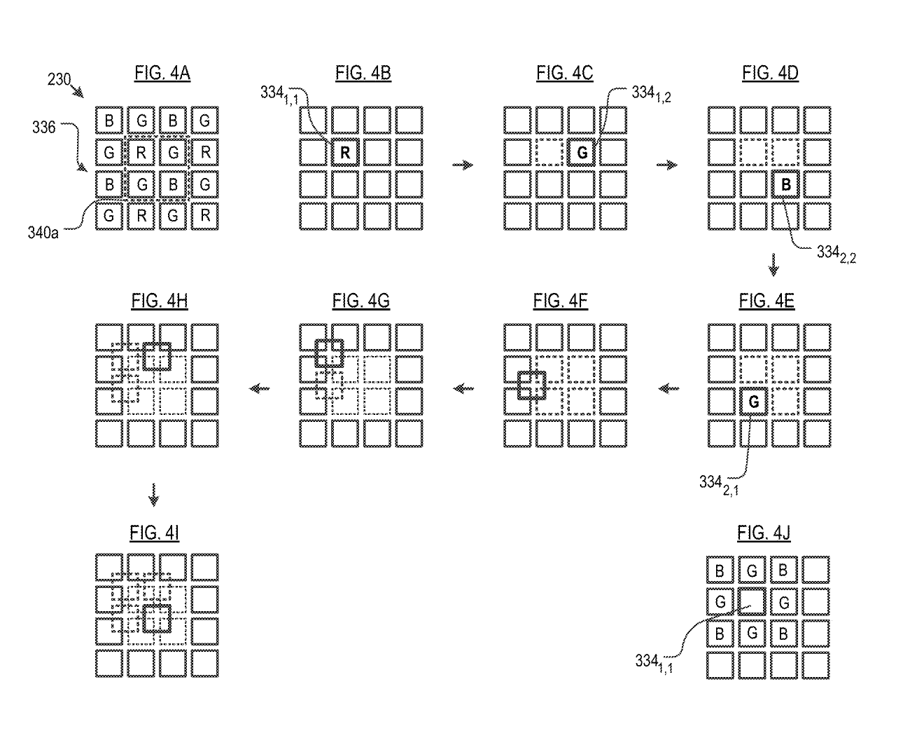

In some embodiments, pixels are super-sampled, to reduce the effective size of a pixel and hence increase the effective resolution of the detector. Super-sampling is distinct from the demosaicing algorithms that are used for estimating the full color palette at each pixel. The sampling and super-sampling technique is illustrated in FIGS. 4A through 4J and described below.

FIG. 4A depicts a portion of detector 230, showing a portion of CFA 336, again implemented as a Bayer filter. Sampling and super-sampling is discussed with respect to 2×2 grid 340a, which is representative of the technique that is used for all such 2×2 grids of CFA 336. Typically, all grids are sampled simultaneously.

FIG. 4B depicts sampling of pixel 334_{1,1}, which is associated with a red filter. FIG. 4C depicts sampling of pixel 334_{1,2}, which is associated with a green filter, FIG. 4D depicts sampling of pixel 334_{2,2}, which is associated with a blue filter. And FIG. 4E depicts sampling of pixel 334_{1,2}, which is associated with a green filter. With the sampling of pixel 334_{1,2}, the entire 2×2 grid 340a (and all other 2×2 grids) has been sampled.

As an example of demosaicing for full color, see FIG. 4J. Pixel 334_{1,1} has a red filter. To estimate the intensity of green wavelengths at pixel 334_{1,1}, the system can, for example, interpolate between the intensity values for green at any two or more of the neighboring pixels. To estimate the intensity of blue wavelengths at pixel 334_{1,1}, the system can, for example, interpolate between the values for blue at any two or more of the two neighboring pixels. It will be appreciated by those skilled in the art that there are many demosaicing algorithms, not all of which involve interpolation techniques.

Super-sampling is illustrated at FIGS. 4F through 4I. As depicted in FIG. 4F, the array is sampled at a location “up” and to the “left” one-half pixel, to add this first “sub-pixel” data set to the image. FIG. 4G depicts the array being sampled at a location that is “up” one pixel from the location sampled in FIG. 4F. This second sub-pixel data set is added to the image, FIG. 4H depicts the array being sampled at a location that is “right” one pixel from the location sampled in FIG. 4G. This third sub-pixel data set is added to the image. And FIG. 4I depicts the array being sampled at a location that is “down” one pixel from the location sampled in FIG. 4H. This fourth and final sub-pixel data set is added to the image.

Thus, image capture has two parts. The initial four samples (FIGS. 4B through 4E) increase color resolution and the second four samples (FIGS. 4F-4I) increase spatial resolution by sampling between the pixels to capture photons that would have fallen between pixels. In embodiments in which super-sampling is used, demosaicing takes place after data from the super-sampling is obtained. In some embodiments, super-sampling is effected by physically moving the imaging array.

In the illustrative embodiment, detector 230 is a consumer camera having a resolution of 4608×3456 pixels and a pixel size of 3.6 microns. Such a camera is commercially available from Olympus Corporation as model OMD E-M5 Mark II. The detector in this camera uses an image stabilization voice coil motor to physically move the sensor array to enable super-sampling of the pixels, in the manner of FIGS. 4F through FIG. 4I. In the case of the referenced camera, super-sampling reduces the effective pixel size from 3.6 microns to 1.8 microns.

Referring now to FIGS. 5A through 5C, optics 228 controls the magnification and field-of-view of microscope 200. In some embodiments, such as depicted in FIG. 5A, optics 228 is objective 542, as used in conventional microscope, and which provides a desired amount of magnification. As will be appreciated by those skilled in the art, a microscope “objective” can comprise a single lens or a collection of lens that collectively provide the desired functionality(ies) (e.g., light gathering, magnification, focus, etc.).

In some other embodiments, optics 228 comprises at least two lens assemblies, 542A and 542B, as depicted in FIG. 5B. These two lens assemblies can be physically coupled to one another or physically separate (but optically coupled). In some embodiments, the two lens assemblies collectively function to make it appear as if the sample being investigated is on detector 230, thereby maximizing field-of-view. In some such embodiments, the two lens assemblies are similar to one another in characteristics and disposed “face-to-face.” In some embodiments, both of the lens assemblies are camera lenses. In some of these embodiments, lens 542A is a reversed upright lens. A reversed upright lens is defined as a camera lens having a focal length that is either fixed or variable, wherein the maximum focal length is equal to 80 percent of the maximum focal length of lens 542B, and a manufacturer specified mounting direction.

In some of these embodiments, lens 542B is a telephoto lens. This enables a user to adjust the field-of-view and resolution without having to refocus or change a lens. Also, it enables a user to zoom in on the center of the sample to remove vignetting. However, in some other embodiments, lens 542B can be a fixed-focal-length lens. In either case, when lens 542A is a reversed upright lens, lens 542B must be adjustable to or fixed at a focal length that is at least 20 percent greater than that of the lens 542A.

FIG. 5C depicts an embodiment in which optics 228 includes reversed upright lens assembly 542A and lens assembly 542B (telephoto or fixed focal length), and mirror 544. In the embodiment shown, lens assemblies 542A and 542B are disposed orthogonally to one another, wherein mirror 544, which is preferably a first surface mirror, is oriented at 45 degrees to re-direct the optical signal leaving lens assembly 542A to lens assembly 542B, and then to detector 230. The first surface mirror is used to avoid the ghosting effect that occurs with a second surface mirror, wherein a faint secondary reflection is observed coming from the front surface of the glass.

In some embodiments, detector 230 is a consumer camera, and telephoto lens 542B is physically attached to the body of the camera.

In the illustrative embodiment in which detector 230 is a consumer camera, such as the Olympus Corporation model OMD E-M5 Mark II, and in which lens assembly 542A is a reversed upright lens, the field-of-view of microscope 200 is 1.7 centimeters (“cm”)×1.5 cm, which is about 25 times larger than a standard fluorescence microscope, as provided by a standard microscope 10× objective. In such an embodiment, the microscope has an optical resolution of 4 microns, a digital resolution of 63,700,9921 pixels, and a data acquisition time of about 1 second. The microscope can multiplex a minimum of three different fluorophores in a single image and can spectrally unmix an image and determine the wavelength of light to within +/−15 nanometers spectral differences.

In some embodiments, detector 230 comprises plural imaging arrays, each with an associated color filter array, arranged in X rows and Y columns. In some such embodiments, the CMOS imaging arrays or imaging “modules” (i.e., defined as having sensor optics and controller in one package) are similar to those found in cell phones. Such modules are designed to be as small and compact as possible—significantly smaller than those found in consumer cameras. The fabrication technology used for producing such modules reduces imaging noise, increases sensitivity and utilizes higher performing onboard sensor controllers (either image signal processors or sensor controllers) enabling higher frame rates at full resolution as much as 24 fps 5344×4016. As optics are reduced in size, it becomes less expensive and easier to create sharper lenses. These modules have pixels about ⅓ the size (1 micron vs 3.6 microns) of larger cameras. As previously discussed, imaging resolution is limited by pixel size.

Each imaging module has a second lens that is reversed and placed on top of the imaging module. The module and lens assembly are mounted to a stage and the stage then scans in either the x direction or x and y directions depending upon the image sensor layout.

The stage can be any electromechanical device(s) that can move in the x and y direction in smaller increments than the sensor's field of view. The stage is powered by a linear movement device, such as a voice-coil motor, a stepper motor similar to those used in a 3d printer, servos, linear actuators, or the like. Smaller movements of the stage are preferred because that reduces the computational burden for image tiling and the resulting image will be of significantly increased quality.

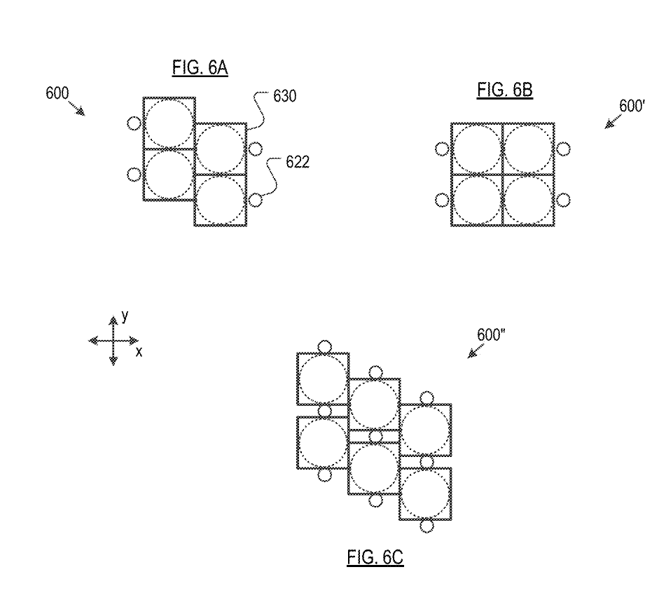

FIGS. 6A-6C depict three arrangements 600, 600′, and 600″ that include plural imaging modules 630. The imaging modules are arrayed to maximize field-of-view overlap and minimize complexity of the scanning stage. The broken circle inscribed within each camera module represents the approximate field-of-view. Each arrangement is depicted as the smallest possible configuration of the array and can be expanded to accommodate additional imaging modules.

For arrangement 600 in FIG. 6A, imaging modules 630 in alternate columns are vertically offset by one-half the module's height in order to create an overlapping field-of-view as the arrangement is scanned in the x direction. The first 1 cm (the approximate width of imaging module 630) of imaging and sensor travel is unusable as it does not have overlapping fields of view from the second column of sensors. The same is true for the last 1 cm of travel. Illumination source (LED) 622 is disposed at the edges of the outermost columns of imaging modules.

Arrangement 600″ in FIG. 6C is similar to arrangement 600, except imaging modules 630 are offset in such a way that the illumination source can be interspersed therebetween to create more even illumination of the sample. Arrangement 600″ is scanned only in the x direction.

In arrangement 600′ of FIG. 6B, scanning occurs in the x and y directions since this arrangement does not have overlapping fields-of-view in one direction. An advantage of this arrangement is that it enables full control over the subject sampling. It may result in a higher quality final image, but this may be at the cost of time.

While scanning, the images are tiled together creating a mosaic image. This is similar to super-sampling, as previously discussed, resulting in increased spatial and color resolution, but at the cost of obtaining an increased number of samples.

It is to be understood that the disclosure teaches just one example of the illustrative embodiment and that many variations of the invention can easily be devised by those skilled in the art after reading this disclosure and that the scope of the present invention is to be determined by the following claims.

1. A fluorescence microscope comprising:
a stage that supports a sample being investigated;
an illumination source that illuminates the sample;
optics, wherein the optics receives an optical signal from the sample, wherein the optical signal comprises reflected light and emitted light; and
a detector, wherein the detector receives the optical signal from the optics, and wherein the detector includes a color filter array and an imaging array, the imaging array comprising a plurality of light-sensitive elements.

2. The fluorescence microscope of claim 1 wherein the illumination source comprises a plurality of light emitting diodes.

3. The fluorescence microscope of claim 1 wherein the optics comprises a microscope objective.

4. The fluorescence microscope of claim 1 wherein the optics comprises a camera lens.

5. The fluorescence microscope of claim 1 wherein the optics comprises a reversed upright lens.

6. The fluorescence microscope of claim 1 wherein the optics comprises a telephoto lens.

7. The fluorescence microscope of claim 1 wherein the optics comprises two camera lens assemblies.

8. The fluorescence microscope of claim 7 wherein the two lens assemblies are physically coupled to one another.

9. The fluorescence microscope of claim 7 wherein the two camera lens assemblies are not co-linear, the optics further comprising a first surface mirror that is arranged to optically couple the two camera lens assemblies.

10. The fluorescence microscope of claim 9 wherein the two camera lens assemblies are disposed orthogonally to one another.

11. The fluorescence microscope of claim 1 wherein the optics comprises a camera lens that produces an image that maps to the detector's entire imaging area.

12. The fluorescence microscope of claim 1 wherein the detector is a consumer camera.

13. The fluorescence microscope of claim 12 wherein the optics comprises a camera lens that is physically attached to the consumer camera.

14. The fluorescence microscope of claim 1 wherein the detector comprises plural imaging arrays.

15. The fluorescence microscope of claim 1 wherein the detector comprises a CMOS imaging array.

16. The fluorescence microscope of claim 1 wherein the color filter array comprises a Bayer filter.

17. The fluorescence microscope of claim 1 wherein the color filter array is super-sampled to decrease an effective pixel size of the imaging array.

18. The fluorescence microscope of claim 1 wherein the stage is movable.
